(19) United States
(12) Patent Application Publication
(10) Pub. No.: US 2022/0169046 A1
(43) Pub. Date: Jun. 2, 2022

(54) PRINTING APPARATUS

(71) Applicant: BROTHER KOGYO KABUSHIKI KAISHA, Nagoya (JP)

(72) Inventor: Mitsugi TANAKA, Nagoya (JP)

(73) Assignee: BROTHER KOGYO KABUSHIKI KAISHA, Nagoya (JP)

(21) Appl. No.: 17/523,458

(22) Filed: Nov. 10, 2021

(30) Foreign Application Priority Data
Nov. 27, 2020 (JP) 2020-197006

(51) Int. Cl. B41J 11/00; B41J 11/42

(52) U.S. Cl. CPC B41J 11/0055; B41J 11/42

(57) ABSTRACT

A first conveyor conveys a print medium in a conveyance direction from a holder toward a print head and in a return direction opposite to the conveyance direction. A tensioner applies back tension to the print medium between the holder and the first conveyor. A first motor drives the first conveyor. The controller controls the print head and the first motor. The controller performs a correction process of controlling the first motor to repeat a first conveyance and a second conveyance sequentially a plurality of times. The first conveyance is conveying the print medium in the conveyance direction in a state where the back tension is applied to the print medium by the tensioner. The second conveyance is conveying the print medium in the return direction in a state where the back tension is not applied to the print medium by the tensioner.

### CROSS REFERENCE TO RELATED APPLICATIONS

This application claims priority from Japanese Patent Application No. 2020-197006 filed Nov. 27, 2020. The entire content of the priority application is incorporated herein by reference.

### BACKGROUND

Conventionally, for a printing apparatus that prints an image on a long print medium, various techniques for correcting skew caused by improper setting of the print medium have been developed. The skew means that a print medium is conveyed obliquely with respect to a reference direction.

### SUMMARY

According to one aspect, this specification discloses a printing apparatus. The printing apparatus includes a holder, a print head, a first conveyor, a tensioner, a first motor, and a controller. The holder is configured to hold a long print medium. The print head is configured to print an image on the print medium fed from the holder. The first conveyor is configured to convey the print medium in a conveyance direction from the holder toward the print head and in a return direction opposite to the conveyance direction. The tensioner is configured to apply back tension to the print medium between the holder and the first conveyor. The first motor is configured to drive the first conveyor. The controller is configured to control the print head and the first motor. The controller is configured to perform a correction process of controlling the first motor to repeat a first conveyance and a second conveyance sequentially a plurality of times. The first conveyance is conveying the print medium in the conveyance direction in a state where the back tension is applied to the print medium by the tensioner. The second conveyance is conveying the print medium in the return direction in a state where the back tension is not applied to the print medium by the tensioner.

The above printing apparatus corrects skew during the first conveyance. During the second conveyance, the printing apparatus conveys the print medium in the return direction while maintaining a state where the inclination of the print medium with respect to the reference direction is corrected by the first conveyance. That is, the printing apparatus reduces an inclination of the print medium with respect to the reference direction due to the back tension being applied during the second conveyance. Thus, by repeating the first conveyance and the second conveyance sequentially, the printing apparatus corrects the skew of the print medium efficiently while avoiding the increase in size of the printing apparatus.

### BRIEF DESCRIPTION OF THE DRAWINGS

Embodiments in accordance with this disclosure will be described in detail with reference to the following figures wherein:

FIG. 1 is a perspective view of a printing apparatus 1;

FIG. 2 is a cross-sectional view showing the internal configuration of the printing apparatus 1;

FIG. 3 is a perspective view of a back tension applying device 8;

FIG. 4A is a cross-sectional view when a contact member 81 of the back tension applying device 8 is located at a front end of a movable range;

FIG. 4B is a cross-sectional view when the contact member 81 of the back tension applying device 8 is located at a rear end of the movable range;

FIG. 5 is a block diagram showing the electrical configuration of the printing apparatus 1;

FIG. 6 is a flowchart of post-replacement printing process; and

FIG. 7 is a cross-sectional view showing the internal configuration of a printing apparatus 60.

### DETAILED DESCRIPTION

A certain printing apparatus corrects skew by, prior to printing, reciprocating a print medium several times in a conveyance direction and in a return direction in a state where the print medium is urged in the direction opposite to the conveyance direction.

In the above printing apparatus, the print medium may be inclined with respect to the reference direction by conveying the print medium in the return direction during skew correction. This is because, when the tensioner of the above printing apparatus applies back tension to the print medium, the print medium may skew due to run-out tolerance of a tape roll of the print medium or the holder holding the tape roll.

In view of the foregoing, an aspect of an objective of this disclosure is to provide a printing apparatus that efficiently corrects skew of a print medium while avoiding upsizing of the printing apparatus.

A printing apparatus 1 according to an embodiment will be described with reference to the drawings. The drawings to be referred to are used to explain the technical features that may be adopted by this disclosure, and the configurations of the devices described are not intended to be limited thereto, but are merely explanatory examples. In the description of the present embodiment, the lower left side, the upper right side, the lower right side, the upper left side, the upper side, and the lower side of FIG. 1 are referred to as the left side, the right side, the front side, the rear side, the upper side, and the lower side of the printing apparatus 1, respectively.

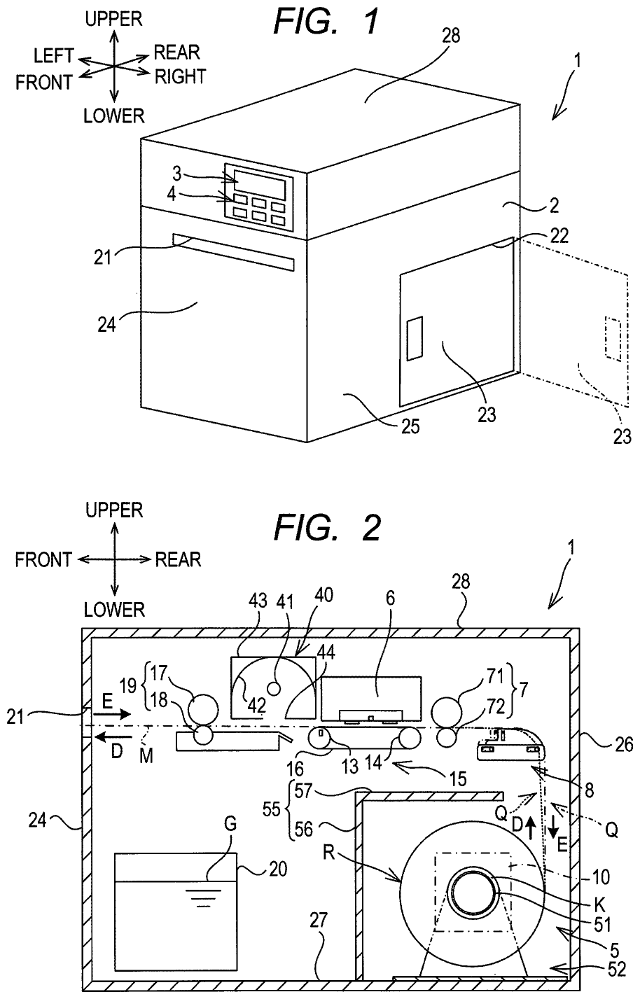

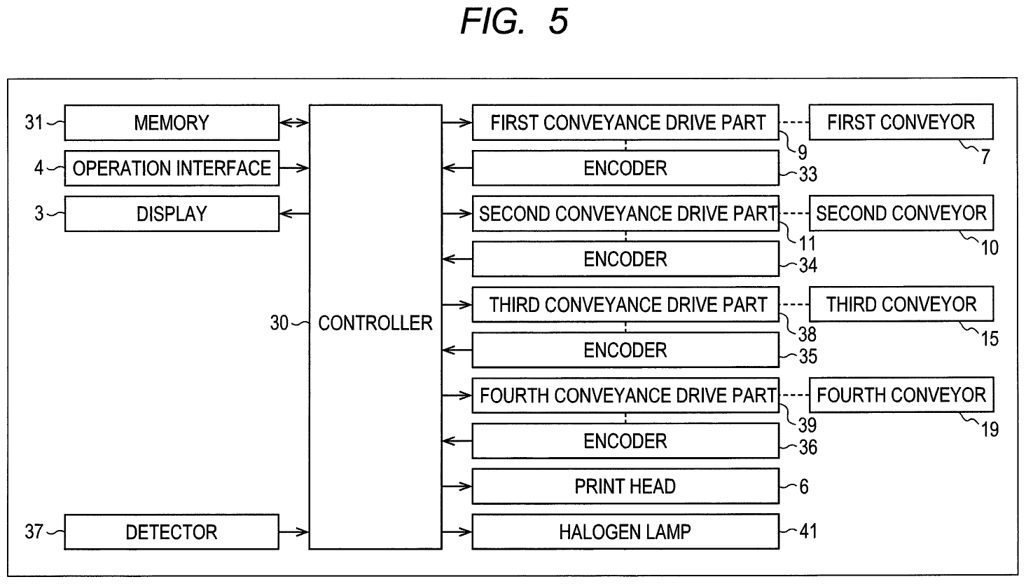

The physical configuration of the printing apparatus 1 will be described with reference to FIGS. 1 to 4B. As shown in FIGS. 1 and 2, the printing apparatus 1 is an inkjet printer that prints on a long print medium M. The print medium M is, for example, a long sheet of paper wound in a roll shape on a tubular paper tube K. The printing apparatus 1 includes a housing 2, a display 3, an operation interface 4, a partition wall 55, a holder 5, a print head 6, a first conveyor 7, a first conveyance drive part 9 (see FIG. 5), a second conveyor 10, a second conveyance drive part 11 (see FIG. 5), a back tension applying device 8 (an example of a tensioner), a fixing unit 40, a third conveyor 15, a third conveyance drive part 38 (see FIG. 5), a fourth conveyor 19, and a fourth conveyance drive part 39 (see FIG. 5).

The housing 2 has a front wall 24, a right wall 25, a rear wall 26, a left wall (not shown), a lower wall 27, an upper wall 28, and a cover 23, and has a rectangular parallelepiped shape having a size that can be placed on a table. The housing 2 is formed with a discharge port 21 and an opening 22. The discharge port 21 is formed on the front wall 24 of the housing 2 in a rectangular shape that is long in the left-right direction in the front view. The opening 22 is formed in a rectangular shape when viewed from the right at the lower rear portion of the right wall 25 of the housing 2. The cover 23 is a rectangular plate when viewed from the right, and is supported at the lower rear part of the right side surface of the housing 2 so as to rotationally move between a closed position for closing the opening 22 (shown by the solid line in FIG. 1) and an open position for opening the opening 22 (shown by the single-dot chain line in FIG. 1). As shown in FIG. 2, the printing apparatus 1 accommodates, inside the housing 2, the holder 5, the print head 6, the first conveyor 7, the back tension applying device 8, the first conveyance drive part 9 (see FIG. 5), the second conveyor 10, and the second conveyance drive part 11 (see FIG. 5). The display 3 is provided at the upper right portion of the front surface of the front wall 24 of the housing 2, and displays an image. The operation interface 4 is provided below the display 3 in the upper right portion of the front surface of the front wall 24 of the housing 2, and includes a plurality of buttons for inputting various instructions. The display 3 and the operation interface 4 are provided above the discharge port 21.

The partition wall 55 includes a first wall portion 56 extending upward from the lower wall 27 of the housing 2 and a second wall portion 57 extending rearward from the upper end of the first wall portion 56, and partitions the internal space of the housing 2. The second wall portion 57 is spaced away from the rear wall 26 of the housing 2 in the front-rear direction. The holder 5 is provided at the left side of the cover 23 at the closed position and in the space surrounded by the partition wall 55 and the housing 2 at the lower rear portion of the printing apparatus 1. The holder 5 holds the long print medium M. The holder 5 holds a roll R in which the print medium M is wound. The holder 5 of the present embodiment includes a shaft portion 51 and a magazine 52. The shaft portion 51 extends in the left-right direction and is inserted into the paper tube K of the roll R. The magazine 52 is a U-shaped support base when viewed from the front, and supports both left and right ends of the shaft portion 51 such that the shaft portion 51 rotates about an axis extending in the left-right direction. The shaft portion 51 is detachably supported by the magazine 52. The magazine 52 is detachably supported by the printing apparatus 1. When a user replaces the roll R, the user disposes the cover 23 at the open position, takes out the magazine 52 from the inside of the housing 2, and performs replacement work of the roll R. The roll R may not have the paper tube K and may be wound in a roll shape so as to be attached to the holder 5.

The print head 6 prints an image on the print medium M fed out from the holder 5. The print head 6 of the present embodiment is an inkjet head that has a plurality of nozzles (not shown) for ejecting liquid Gin an ejection direction, and that prints an image on the print medium M by ejecting the liquid G from the plurality of nozzles. The ejection direction of the present embodiment is downward, and the print head 6 is provided above a conveyance path Q of the print medium M in a posture in which the plurality of nozzles face downward. The conveyance path Q is a path along which the print medium M is fed out from the holder 5 and conveyed to the outside of the housing 2 through the discharge port 21. The liquid G is supplied from a tank 20 arranged inside the housing 2 to the print head 6 via a tube (not shown).

The first conveyor 7 conveys the print medium M in a conveyance direction D from the holder 5 toward the print head 6 and in a return direction E opposite to the conveyance direction D. The conveyance direction D is a direction along the conveyance path Q from the holder 5 toward the print head 6. The conveyance direction D is a direction crossing the left-right direction which is the extending direction of the rotation axis of the roll R, and changes depending on the position on the conveyance path Q. The conveyance direction D from the holder 5 to the back tension applying device 8 changes depending on the remaining amount of the print medium M, and is substantially upward when the remaining amount of print medium M is the initial value (the remaining amount immediately after the roll R is replaced) as shown in FIG. 2. The conveyance direction D from the back tension applying device 8 to the discharge port 21 is substantially forward. That is, in the printing apparatus 1, at the portion where the print medium

M contacts the back tension applying device 8, the conveyance path Q bends (curves) and the conveyance direction D changes from upward to forward.

The first conveyor 7 is provided upstream of the print head 6 in the conveyance direction and downstream of the holder 5 in the conveyance direction. That is, the first conveyor 7 is provided between the print head 6 and the holder 5 in the conveyance path Q of the print medium M. The first conveyor 7 of the present embodiment includes a conveyance roller 71 and a pinch roller 72 each of which rotates about an axis extending in the left-right direction, and perform a nip conveyance by vertically sandwiching the print medium M between the conveyance roller 71 and the pinch roller 72. The first conveyance drive part 9 drives the first conveyor 7 to rotate. The first conveyance drive part 9 is, for example, a stepping motor configured to rotate in forward and reverse directions.

The second conveyor 10 is provided downstream of the first conveyor 7 in the return direction E (upstream of the first conveyor 7 in the conveyance direction D), and conveys the print medium M in the return direction E. The second conveyor 10 of the present embodiment rotates the roll R held by the holder 5 to convey the print medium M in the return direction E, thereby winding the print medium M on the roll R. The second conveyor 10 includes a coupling that detachably engages with the shaft portion 51 of the holder 5, and transmits the drive force of the second conveyance drive part 11 described later to the shaft portion 51 to rotate the shaft portion 51. The second conveyor 10 conveys the print medium M in the conveyance direction D and in the return direction E. The second conveyor 10 rotates the roll R held by the holder 5 to send out the print medium M on the roll R toward the print head 6 in the conveyance direction D. The second conveyance drive part 11 drives the second conveyor 10 to rotate under the control of the controller 30. The second conveyance drive part 11 is, for example, a stepping motor configured to rotate in forward and reverse directions.

The back tension applying device 8 applies back tension to the print medium M between the holder 5 and the first conveyor 7 in the conveyance path Q. The back tension is tension that acts in the direction opposite to the traveling direction of the print medium M. The back tension applying device 8 is arranged upstream of the first conveyor 7 in the conveyance direction and downstream of the second conveyor 10 in the conveyance direction, and contacts the print medium M to urge the print medium M in a direction crossing the conveyance direction D. That is, the back tension applying device 8 is provided between the first conveyor 7 and the second conveyor 10 in the conveyance path Q. The back tension applying device 8 is provided rearward of the first conveyor 7 and above the holder 5. The back tension applying device 8 is provided at a corner of the conveyance path Q at which the conveyance direction D changes from upward to forward.

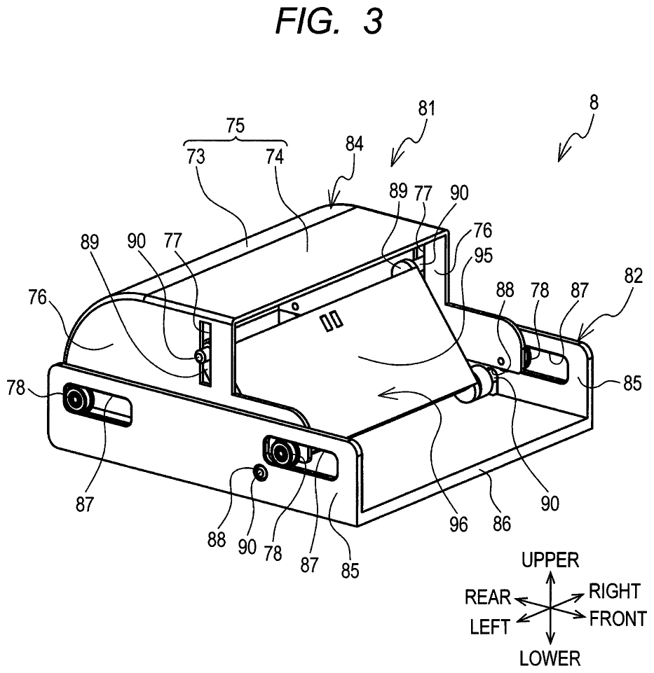

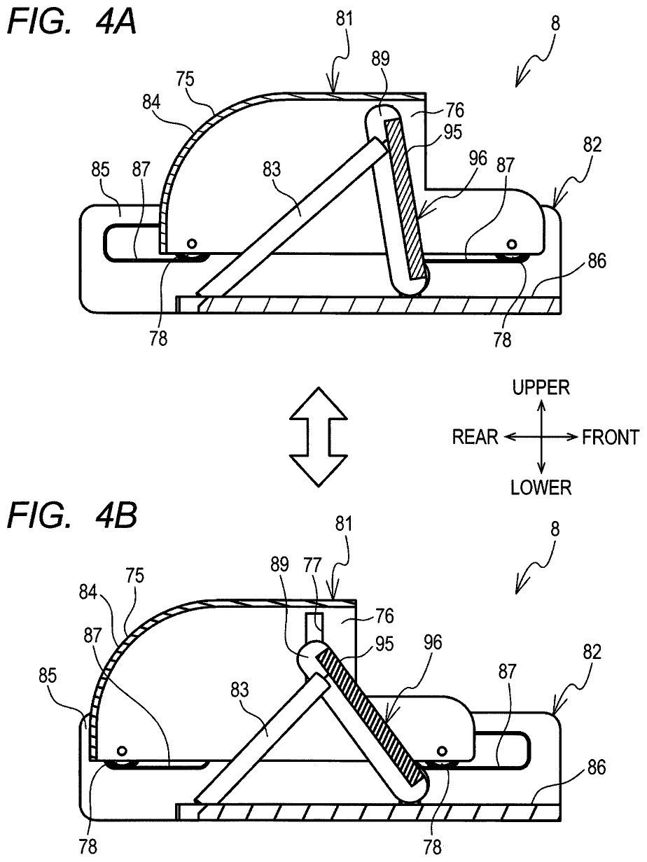

As shown in FIGS. 3 and 4, the back tension applying device 8 includes a contact member 81, a guide member 96, a support member 82, and an urging member 83. The contact member 81 has a contact portion 75, a pair of left and right side walls 76, and two pairs of front and rear rollers 78. The contact portion 75 has a contact surface 84 that contacts the lower surface of the print medium M. The contact portion 75 includes a curved portion 73 and a linear portion 74. The curved portion 73 is a portion that is curved so as to be convex toward the rear in a right side view. The linear portion 74 is a portion extending forward from the front end of the curved portion 73. The length of the contact portion 75 in the left-right direction is longer than the length in the width direction of the print medium M. The upper end position of the contact surface 84 is substantially the same as the upper end position of the pinch roller 72, that is, the vertical position of the portion where the print medium M is nipped by the first conveyor 7. In the vertical direction, the upper end position of the contact surface 84 is between the upper end and the lower end of the discharge port 21. The pair of left and right side walls 76 has a planar shape extending downward from both left and right ends of the contact portion 75. A rectangular guide hole 77 that is long in the vertical direction in a side view is formed in the pair of side walls 76. One pair of front and rear rollers 78 is supported on a lower part of the right surface of the right side wall 76 so as to be rotatable about an axis extending in the left-right direction. The other pair of front and rear rollers 78 is supported on a lower part of the left surface of the left side wall 76 so as to be rotatable about an axis extending in the left-right direction.

The guide member 96 is arranged between the pair of left and right side walls 76 of the contact member 81 in the left-right direction, and guides the movement of the contact member 81 in the front-rear direction. The guide member 96 includes a plate portion 95, a pair of left and right side walls 89, and two pairs of upper and lower pins 90. The pair of left and right side walls 89 extends downward from both left and right ends of the plate portion 95. The pair of upper and lower pins 90 projecting to the right side is provided on the right surface of the right side wall 89. The upper pin 90 is inserted into the guide hole 77 of the right side wall 76 from the left side. The lower pin 90 is inserted into the hole 88 of the right side wall 85 of the support member 82 described later from the left side. The pair of upper and lower pins 90 projecting to the left side is provided on the left surface of the left side wall 89. The upper pin 90 is inserted into the guide hole 77 of the left side wall 76 from the right side. The lower pin 90 is inserted into the hole 88 of the left side wall 85 of the support member 82 described later from the right side. The guide member 96 is supported by the support member 82 so as to rotationally movable about the pair of left and right pins 90 at the lower side.

The support member 82 supports the contact member 81 so as to be movable in the front-rear direction. The support member 82 includes a main body 86 and a pair of left and right side walls 85. The main body 86 has a planar shape extending in a horizontal direction, and is provided below the contact member 81 and the guide member 96. The pair of left and right side walls 85 extends upward from both left and right ends of the main body 86. In the left-right direction, the contact member 81 is arranged between the pair of left and right side walls 85. Each side wall 85 includes a pair of front and rear guide holes 87 and a hole 88. The pair of front and rear guide holes 87 has a rectangular shape that is long in the front-rear direction in a side view. The hole 88 has a circular shape in a side view, and is provided below and behind the front guide hole 87. The pair of front and rear rollers 78 of the right side wall 76 is inserted into the pair of front and rear guide holes 87 of the right side wall 85 from the left side, respectively. The lower pin 90 of the right side wall 89 is inserted into the hole 88 of the right side wall 85 from the left side. The pair of front and rear rollers 78 of the left side wall 76 is inserted into the pair of front and rear guide holes 87 of the left side wall 85 from the right side, respectively. The lower pin 90 of the left side wall 89 is inserted into the hole 88 of the left side wall 85 from the right side. The contact member 81 is movable relative to the support member 82 in the front-rear direction within the range defined by the guide hole 87.

The urging member 83 urges the contact member 81 in a direction crossing the conveyance direction. The urging member 83 is, for example, a coil spring. One end of the urging member 83 is fixed to the rear end of the main body 86 of the support member 82, and the other end of the urging member 83 is fixed to the upper end of the plate portion 95 of the guide member 96. The contact member 81 is urged rearward by the guide member 96. FIG. 4A shows a state where the contact member 81 is located at the front end of the movable range against the urging force of the urging member 83, and FIG. 4B shows a state where the contact member 81 is located at the rear end of the movable range against the urging force of the urging member 83. The back tension applying device 8 applies tension acting in the return direction to the print medium M that is conveyed in the conveyance direction D between the back tension applying device 8 and the first conveyor 7 by the urging force of the urging member 83. The back tension applying device 8 (specifically, the contact member 81) is configured to contact the print medium M and press the print medium M in a direction crossing the conveyance direction D.

As shown in FIG. 2, the fixing unit 40 is arranged downstream of the print head 6 in the conveyance direction and upstream of the fourth conveyor 19 in the conveyance direction. The fixing unit 40 is a halogen heater and has a halogen lamp 41, a reflector 42, and a housing 43. An opening 44 is formed in the lower wall of the housing 43 along the left-right direction. The fixing unit 40 radiates infrared light through the opening 44 and heats the print medium M passing directly below the opening 44. In this way, the liquid G ejected onto the print medium M by the print head 6 is fixed on the print medium M.

The third conveyor 15 is provided below the print head 6 and downstream of the first conveyor 7 in the conveyance direction, and conveys the print medium M in the conveyance direction D. The third conveyor 15 includes a drive roller 13, a follow roller 14, and an endless belt 16. The drive roller 13 and the follow roller 14 are separated from each other in the front-rear direction. The endless belt 16 is stretched over the drive roller 13 and the follow roller 14.

The drive roller 13 is rotated by a driving force from the third conveyance drive part 38 to rotate the endless belt 16. The follow roller 14 rotates due to rotation of the endless belt 16. The upper end of the outer peripheral surface of the endless belt 16 is substantially at the same vertical position as the portion where the print medium M is nipped by the first conveyor 7, and faces the plurality of nozzles of the print head 6. The upper end of the outer peripheral surface of the endless belt 16 supports, from below, and conveys the print medium M that is conveyed between the first conveyor 7 and the fourth conveyor 19 in the conveyance direction D. The third conveyance drive part 38 is, for example, a stepping motor.

The fourth conveyor 19 is provided downstream of the print head 6 and the fixing unit 40 in the conveyance direction and upstream of the discharge port 21 in the conveyance direction, and conveys the print medium M in the conveyance direction D and in the return direction E. The fourth conveyor 19 has a conveyance roller 17 and a pinch roller 18 each of which rotates about an axis extending in the left-right direction, and performs nip-conveyance of the print medium M by sandwiching the print medium M between the conveyance roller 17 and the pinch roller 18 in the vertical direction. The fourth conveyance drive part 39 is, for example, a stepping motor configured to rotate in forward and reverse directions.

The electrical configuration of the printing apparatus 1 will be described with reference to FIG. 5. The printing apparatus 1 includes a controller 30, and a memory 31, an operation interface 4, a display 3, a first conveyance drive part 9, a second conveyance drive part 11, a third conveyance drive part 38, a fourth conveyance drive part 39, a print head 6, a halogen lamp 41, encoders 33 to 36, and a detector 37 electrically connected to the controller 30. The controller 30 performs control of the printing apparatus 1, and controls the print head 6, the halogen lamp 41, the first conveyance drive part 9, the second conveyance drive part 11, the third conveyance drive part 38, and the fourth conveyance drive part 39. The memory 31 includes a ROM, a RAM, a flash memory, and so on that store various parameters and so on necessary when the controller 30 executes various programs.

The encoder 33 inputs a value corresponding to the driving amount of the first conveyance drive part 9 to the controller 30. The encoder 34 inputs a value corresponding to the driving amount of the second conveyance drive part 11 to the controller 30. The encoder 35 inputs a value corresponding to the driving amount of the third conveyance drive part 38 to the controller 30. The encoder 36 inputs a value corresponding to the driving amount of the fourth conveyance drive part 39 to the controller 30. The detector 37 outputs, to the controller 30, a detection result according to the back tension applied to the print medium M located between the back tension applying device 8 and the first conveyor 7 by the back tension applying device 8. Specifically, the detector 37 detects the position of the contact member 81 of the back tension applying device 8. The back tension may be estimated from the position of the contact member 81. For example, the back tension may be estimated based on the technique described in Japanese Patent Application Publication No. 2021-95289.

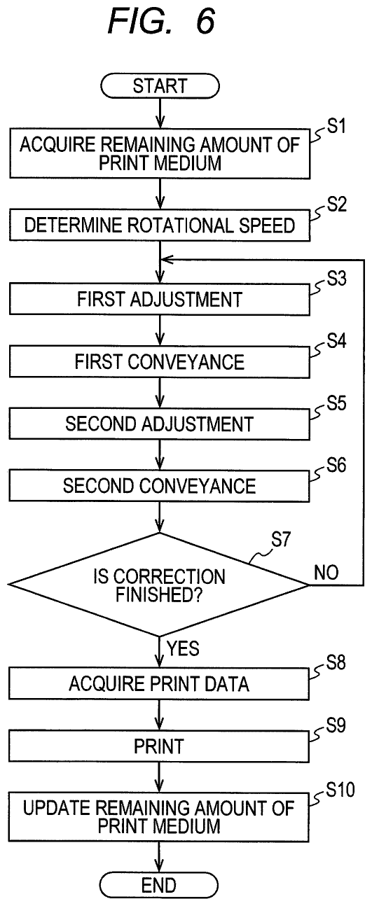

The post-replacement printing process executed by the controller 30 of the printing apparatus 1 will be described with reference to FIG. 6. The post-replacement printing process is executed when a print instruction is first detected after the print medium M is replaced in the printing apparatus 1. The instruction includes a command for correcting the skew of the print medium M and print data. The skew of the present embodiment means that the print medium M is conveyed in a posture in which the longitudinal direction of the print medium M is inclined with respect to the conveyance direction D. That is, in the present embodiment, the conveyance direction D is defined as the reference direction. In the following description, each processing step is abbreviated as “S”. At the start of the post-replacement printing process, the print medium M is nipped by the first conveyor 7.

As shown in FIG. 6, the controller 30 acquires the remaining amount of the print medium M (S1). An initial value of the remaining amount of the print medium M immediately after the print medium M is replaced is set and stored in the memory 31. The remaining amount is updated according to the print length for each print of the print medium M. The remaining amount of the print medium M immediately after the print medium M is replaced may be a value specified by the user and input through the operation interface 4. The controller 30 determines the rotational speed of the second conveyor 10 by the second conveyance drive part 11 based on the remaining amount acquired in S1 (S2). The relationship between the remaining amount of the print medium M and the rotational speed is stored in advance in the memory 31. When the remaining amount of the print medium M is larger, the controller 30 sets the rotational speed to a smaller value. The controller 30 controls the first conveyance drive part 9 to execute a correction process of sequentially repeating first conveyance and second conveyance a plurality of times (S3 to S7). The first conveyance is conveying the print medium M in the conveyance direction D in a state where back tension is applied to the print medium M by the back tension applying device 8. The second conveyance is conveying the print medium M in the return direction E in a state where back tension is not applied to the print medium M by the back tension applying device 8. The controller 30 of the present embodiment controls the first conveyance drive part 9 and the second conveyance drive part 11 such that a first length of the print medium M between the first conveyor 7 and the second conveyor 10 during the first conveyance is shorter than a second length of the print medium M between the first conveyor 7 and the second conveyor 10 during the second conveyance.

Specifically, the controller 30 performs first adjustment of controlling the second conveyance drive part 11 to drive the second conveyor 10 to convey the print medium M in the return direction E until a first condition is satisfied in a state where the conveyance of the print medium M by the first conveyor 7 is stopped (S3). By performing the first adjustment (S3), the print medium M is stretched between the first conveyor 7 and the second conveyor 10, and, thus, the tension is applied to the print medium M. Furthermore, the print medium M is stretched on the back tension applying device 8. The first condition may be a particular condition in which the first length is shorter than the second length, and is, for example, a condition in which the detection result of the detector 37 is within a particular range. The first condition may be defined by the amount of conveyance in the return direction E by the second conveyor 10. By the first adjustment, the contact member 81 of the back tension applying device 8 is located at the front end of the movable range indicated by the single-dot chain line in FIG. 2. The first length of the portion between the first conveyor 7 and the second conveyor 10 of the conveyance path Q indicated by the dotted line in FIG. 2 is shorter than the second length of the portion between the first conveyor 7 and the second conveyor 10 of the conveyance path Q indicated by the single-dot chain line in FIG. 2.

When the first adjustment (S3) ends, the controller 30 performs first conveyance of controlling the first conveyance drive part 9 and the second conveyance drive part 11 to drive the first conveyor 7 and the second conveyor 10 to convey the print medium M in the conveyance direction D in a state where a particular range of back tension is applied to the print medium M (S4). The controller 30 sets the rotational speed of the second conveyor 10 driven by the second conveyance drive part 11 to the rotational speed which has been determined in S2. The particular range is stored in the memory 31. The controller 30 performs feedback control of periodically acquiring a detection result of the detector 37 during the execution of the first conveyance and, based on the acquired detection result, performing control such that the back tension applied to the print medium M between the back tension applying device 8 and the first conveyor 7 is within the particular range. When the acquired detection result is not within the particular range, the controller 30 controls the second conveyance drive part 11 to adjust the rotational speed of the roll R by the second conveyor 10 based on the acquired detection result. When the controller 30 makes the rotational speed of the roll R slower than the current rotational speed, the back tension applied to the print medium M becomes larger than the current value. When the controller 30 makes the rotational speed of the roll R faster than the current rotational speed, the back tension applied to the print medium M becomes smaller than the current value. In the first conveyance, since the print medium M is conveyed in the conveyance direction D in a state where back tension is applied, the skew of the print medium M is corrected so that the longitudinal direction of the print medium M is parallel to the conveyance direction D. When the print medium M is conveyed by a particular length, the controller 30 ends the first conveyance.

After the first conveyance (S4), the controller 30 performs second adjustment of controlling the first conveyance drive part 9 to drive the first conveyor 7 to convey the print medium M in the return direction E until a second condition is satisfied in a state where the conveyance of the print medium M in the conveyance direction D by the second conveyor 10 is stopped (S5). By performing the second adjustment (S5), the print medium M floats above or rearward, and, thus, the print medium M is released from the back tension applying device 8. The second condition may be a particular condition that the first length is shorter than the second length. For example, the second condition is a condition that it is determined, based on the detection result of the detector 37, that the back tension applying device 8 is not applying tension to the print medium M. In this case, the second condition may be defined by the amount of conveyance in the return direction E by the first conveyor 7. Alternatively, as a modification, the controller 30 may perform second adjustment of controlling the second conveyance drive part 11 to drive the second conveyor 10 to convey the print medium M in the conveyance direction D until the second condition is satisfied in a state where the conveyance of the print medium M by the first conveyor 7 is stopped (modification of S5). In this modification, the second condition may be defined by the amount of conveyance in the conveyance direction D by the second conveyor 10. By the second adjustment, the contact member 81 of the back tension applying device 8 is located at the rear end of the movable range indicated by the solid line in FIG. 2, and the second length is longer than the first length. In the present embodiment, by performing the second adjustment, the print medium M is partially raised and separated from the back tension applying device 8 (specifically, the contact member 81).

In response to end of the second adjustment (S5), the controller 30 performs second conveyance of controlling the first conveyance drive part 9 and the second conveyance drive part 11 to drive the first conveyor 7 and the second conveyor 10 to convey the print medium M in the return direction E (S6). Since the print medium M has been released from the back tension applying device 8 by the second adjustment (S5), the print medium M is conveyed in the return direction E while the print medium M is kept released from the back tension applying device 8 during the second conveyance (S6). Therefore, skew of the print medium M, which may be caused by run-out tolerance of the roll R of the print medium M or the holder 5 holding the roll R, may be limited since the back tension applying device 8 may be kept from applying back tension to the print medium M during the second conveyance (S6). In the second conveyance, the controller 30 of the present embodiment controls the first conveyance drive part 9 and the second conveyance drive part 11 to drive the first conveyor 7 and the second conveyor 10 to convey the print medium M in the return direction E and convey the print medium M to the holder 5. The controller 30 adjusts the rotational speed of the roll R by the second conveyor 10 during the second conveyance to the value set in S2, that is, the value based on the amount of the print medium M wound around the roll R. In response to conveying the print medium M by a particular length, the controller 30 ends the second conveyance. The particular length may be the same as or different from the particular length of S4.

The controller 30 determines whether the correction process is finished (S7). The controller 30 determines that the correction process is finished, for example, when the processes from the first adjustment to the second conveyance are performed a particular number of times which is stored in the memory 31. The particular number of times is set in consideration of the conveyance amount that is conveyable by one first conveyance and the conveyance amount in the conveyance direction D necessary for correcting the skew of the print medium M, and for example, is set by an experiment in advance. In a case where the printing apparatus 1 includes a detector configured to detect the inclination of the print medium M with respect to the reference direction downstream of the first conveyor 7 in the conveyance direction, the controller 30 may determine that the correction process is finished when it is determined by the detector that the inclination of the print medium M with respect to the reference direction falls within a particular range. If the correction process is not finished (S7: NO), the controller 30 returns the process to S3.

When the correction process is finished (S7: YES), the controller 30 acquires the print data included in the start instruction (S8). Based on the print data acquired in S8, the controller 30 drives the print head 6, the first conveyance drive part 9, the second conveyance drive part 11, the third conveyance drive part 38, the fourth conveyance drive part 39, and the halogen lamp 41 to perform a printing process (S9). Specifically, the controller 30 drives the first conveyance drive part 9, the second conveyance drive part 11, the third conveyance drive part 38, and the fourth conveyance drive part 39 to convey the print medium M. The controller 30 may set the rotational speed of the second conveyance drive part 11 to a value corresponding to the remaining amount acquired in 51. The controller 30 drives the print head 6 in synchronization with the conveyance of the print medium M to eject the liquid G to the print medium M. The controller 30 drives the halogen lamp 41 to fix the liquid G on the print medium M. The controller 30 updates the remaining amount acquired in 51 based on the amount of the print medium M used for printing in S9, and stores the updated remaining amount in the memory 31 (S10). In this way, the controller 30 ends the post-replacement printing process.

In the above embodiment, the printing apparatus 1, the holder 5, the print head 6, the first conveyor 7, the back tension applying device 8, the first conveyance drive part 9, the second conveyor 10, the second conveyance drive part 11, and the controller 30 are examples of a printing apparatus, a holder, a print head, a first conveyor, a tensioner, a first motor, a second conveyor, a second motor, and a controller of the present disclosure, respectively. The process of S3 is an example of first adjustment of the present disclosure, the process of S4 is an example of first conveyance of the present disclosure, the process of S5 is an example of second adjustment of the present disclosure, and the process of S6 is an example of second conveyance of the present disclosure. The processing of S3 to S7 is an example of a correction process of the present disclosure.

The printing apparatus 1 of the above embodiment includes the holder 5, the print head 6, the first conveyor 7, the back tension applying device 8, the first conveyance drive part 9, and the controller 30. The holder 5 holds a long print medium M. The print head 6 prints an image on the print medium M fed out from the holder 5. The first conveyor 7 conveys the print medium M in the conveyance direction D from the holder 5 toward the print head 6 and in the return direction E opposite to the conveyance direction D. The back tension applying device 8 applies back tension to the print medium M between the holder 5 and the first conveyor 7. The first conveyance drive part 9 drives the first conveyor 7. The controller 30 controls the print head 6 and the first conveyance drive part 9. The controller 30 executes a correction process in which the first conveyance and the second conveyance are sequentially repeated a plurality of times (S3 to S7). In the first conveyance, the controller 30 controls the first conveyance drive part 9 to convey the print medium M in the conveyance direction D in a state where back tension is applied to the print medium M by the back tension applying device 8 (S4). In the second conveyance, the controller 30 conveys the print medium M in the return direction E in a state where the back tension applying device 8 does not apply back tension to the print medium M (S6). The printing apparatus 1 corrects the skew during the first conveyance. During the second conveyance, the printing apparatus 1 conveys the print medium M in the return direction E while maintaining a state where the inclination of the print medium M with respect to the reference direction is corrected by the first conveyance. That is, the printing apparatus 1 suppresses an inclination of the print medium M with respect to the reference direction due to the back tension being applied during the second conveyance. Thus, by repeating the first conveyance and the second conveyance sequentially, the printing apparatus 1 corrects the skew of the print medium M efficiently while avoiding the increase in size of the printing apparatus 1.

The printing apparatus 1 includes the second conveyor 10 provided downstream of the first conveyor 7 in the return direction E to convey the print medium M in the return direction E and the second conveyance drive part 11 that drives the second conveyor 10 under the control of the controller 30. In the second conveyance, the controller 30 controls the first conveyance drive part 9 and the second conveyance drive part 11 to drive the first conveyor 7 and the second conveyor 10 to convey the print medium M in the return direction E and convey the print medium M to the holder 5 (S6). The printing apparatus 1 conveys the print medium M to the holder 5 more reliably during the second conveyance than a case where the second conveyor 10 is not provided. Thus, the printing apparatus 1 prevents an increase in the size of the printing apparatus 1 in order to secure a space for accommodating the print medium M sent to the downstream side of the first conveyor 7 in the conveyance direction D during the second conveyance.

The holder 5 holds the roll R around which the print medium M is wound. The second conveyor 10 rotates the roll R held by the holder 5, conveys the print medium M in the return direction E, and winds the print medium M around the roll R. The printing apparatus 1 winds the print medium M on the roll R during the second conveyance. Thus, the printing apparatus 1 prevents an increase in the size of the printing apparatus 1 in order to secure a space for accommodating the print medium M sent to the downstream side of the first conveyor 7 in the conveyance direction D during the second conveyance.

The controller 30 adjusts the rotational speed of the roll R by the second conveyor 10 during the second conveyance depending on the amount of the print medium M wound around the roll R (Si, S2, and S6). The printing apparatus 1 prevents the change in the returning speed of the print medium M due to the change of the amount of the print medium M wound around the roll R as compared with a case where the roll R is rotated at a constant speed regardless of the change of the amount of the print medium M wound around the roll R.

The controller 30 controls the first conveyance drive part 9 and the second conveyance drive part 11 such that the first length of the print medium M between the first conveyor 7 and the second conveyor 10 during the first conveyance is shorter than the second length of the print medium M between the first conveyor 7 and the second conveyor 10 during the second conveyance. The printing apparatus 1 simplifies the configuration for performing the first conveyance and the second conveyance as compared with a case where the first length is longer than or equal to the second length.

More specifically, during conveyance in the return direction E, when the first conveyor 7 is rotated reversely in a state where the second conveyor 10 is stopped, the print medium M curves and separates from the contact surface 84 momentarily. In this state, the length of the print medium M between the first conveyor 7 and the second conveyor 10 is longer than a state where the print medium M contacts the contact surface 84, that is, the print medium M is stretched. In the present application, this is referred to as “the first length is shorter than the second length”. By conveying the print medium M in the return direction E in a state where the print medium M is separated from the contact surface 84, that is, the print medium M is not stretched, the print medium M is conveyed in the return direction E in a state where the back tension applying device 8 does not apply back tension to the print medium M. This reduces skew of the print medium M due to back tension applied when the print medium M is conveyed in the return direction E. Here, if the first length is greater than or equal to the second length, the print medium M is stretched when the print medium M is conveyed in the return direction E, and the print medium M is separated from the contact surface 84 when the print medium M is conveyed in the conveyance direction D. In this case, back tension cannot be applied when the print medium M is conveyed in the conveyance direction D, and unnecessary tension is applied when the print medium M is conveyed in the return direction E, which leads to an occurrence of skew.

In response to acquiring the command to perform the correction process, the controller 30 performs first adjustment of controlling the second conveyance drive part 11 to drive the second conveyor 10 to convey the print medium M in the return direction E until the first condition is satisfied in a state where the conveyance of the print medium M by the first conveyor 7 is stopped (S3). In response to finishing the first adjustment, the controller 30 performs first conveyance of controlling the first conveyance drive part 9 and the second conveyance drive part 11 to drive the first conveyor 7 and the second conveyor 10 to convey the print medium M in the conveyance direction D in a state where back tension of a particular range is applied to the print medium M (S4). After the first conveyance (S4), the controller 30 performs second adjustment of controlling the first conveyance drive part 9 to drive the first conveyor 7 to convey the print medium M in the return direction E until the second condition is satisfied in a state where the conveyance of the print medium M in the conveyance direction D by the second conveyor 10 is stopped (S5). In response to finishing the second adjustment (S5), the controller 30 performs second conveyance of controlling the first conveyance drive part 9 and the second conveyance drive part 11 to drive the first conveyor 7 and the second conveyor 10 to convey the print medium M in the return direction E (S6). The controller 30 repeats the first adjustment (S3), the first conveyance (S4), the second adjustment (S5), and the second conveyance (S6) sequentially a plurality of times (S7). The printing apparatus 1 makes the first length shorter than the second length by adjusting the driving timing of the first conveyor 7 and the second conveyor 10 during the first conveyance.

The back tension applying device 8 is arranged upstream of the first conveyor 7 in the conveyance direction and downstream of the second conveyor 10 in the conveyance direction, and contacts and urges the print medium M in the direction crossing the conveyance direction D. In the printing apparatus 1, back tension applied to the print medium M becomes more stable as compared with a configuration in which back tension is applied to the print medium M by controlling the conveyance speeds of the first conveyor 7 and the second conveyor 10 during the first conveyance. In this way, the printing apparatus 1 stably corrects the skew of the print medium M during the first conveyance.

While the disclosure has been described in detail with reference to the above aspects thereof, it would be apparent to those skilled in the art that various changes and modifications may be made therein without departing from the scope of the claims. For example, the following modifications may be made.

The holder 5 may hold a long print medium, and the configuration of the holder 5 may be changed as appropriate. The first conveyor 7 may convey the print medium M by another conveyance member such as a conveyance belt. The second conveyor 10 may be configured to convey the print medium M only in the return direction E. The configuration of the second conveyor 10 may be changed according to the configuration of the holder 5. Further, the second conveyor 10 may be omitted. The rotational speed of the second conveyor 10 during the second conveyance may be unchanged regardless of the remaining amount of print medium M.

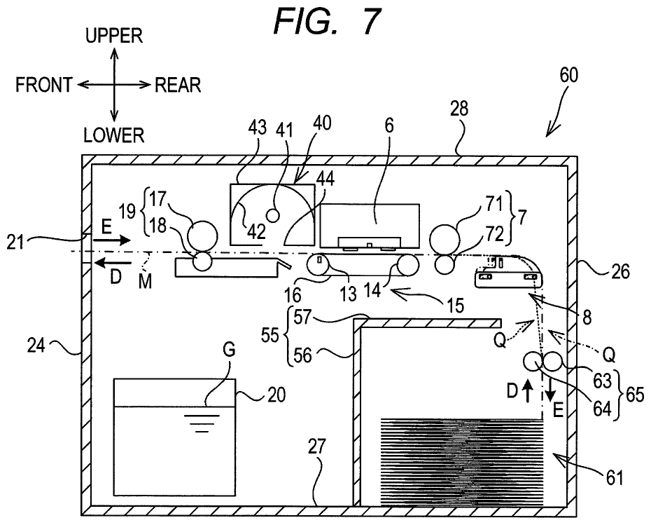

The print medium M may be fanfold paper that is folded along the perforations carved on the paper. In that case, in a printing apparatus 60 according to a modification shown in FIG. 7, a holder 61 may be provided in place of the holder 5 of the printing apparatus 1, and a second conveyor 65 may be provided in place of the second conveyor 10. In FIG. 7, the same reference numerals are given to the same configurations as those in the above embodiment. The other configurations of the printing apparatus 60 of the modification are the same as those of the printing apparatus 1 of the above embodiment. As shown in FIG. 7, the holder 61 has a space surrounded by the partition wall 55 and the housing 2, and holds the fanfold paper in a folded state. The second conveyor 65 is provided downstream of the holder 61 in the conveyance direction D and upstream of the back tension applying device 8 in the conveyance direction D. The second conveyor 65 conveys the print medium M in the conveyance direction D and in the return direction E. The second conveyor 65 includes a conveyance roller 63 and a pinch roller 64 each of which rotates about an axis extending in the left-right direction, and performs a nip conveyance by sandwiching the print medium M in the front-rear direction between the conveyance roller 63 and the pinch roller 64. The second conveyance drive part 11 of the modification may be, for example, a stepping motor configured to drive the conveyance roller 63 to rotate in the forward and reverse directions.

The configuration of the print head 6 may be appropriately changed, and may be an inkjet head configured for color printing, or an electrophotographic or thermal head. The fixing unit 40 may be omitted or the configuration may be changed depending on the printing method of the printing apparatus 1. The printing apparatus 1 may include a cutter for cutting the print medium M after printing along the width direction. At least one of the third conveyor 15 and the fourth conveyor 19 may be omitted as appropriate, or the configuration may be changed.

The configuration of the back tension applying device 8 may be changed as appropriate. For example, the back tension applying device 8 may apply back tension to the print medium M by applying a particular frictional force to the shaft portion 51 when the roll R rotates in the direction in which the print medium M is fed out (counterclockwise when viewed from the right side). In a case where the back tension applying device 8 includes an urging member 83, the urging member 83 may be appropriately changed, for example, to a leaf spring and so on. The printing apparatus 1 may apply back tension to the print medium M by adjusting the conveyance speed of the print medium M by the first conveyor 7 and the conveyance speed of the print medium M by the second conveyor 10. In this case, the first conveyance drive part 9 and the second conveyance drive part 11 serve as the back tension applying device. The relationship between the first length and the second length may be appropriately changed according to the configuration of the back tension applying device 8. The first length and the second length may be the same as each other or different from each other.

The program including commands for executing the post-replacement printing process of FIG. 6 may be stored in a storage device of the printing apparatus 1 by the time the controller 30 executes the program. Thus, each of the acquisition method of the program, the acquisition route, and the device for storing the program may be appropriately changed. The program executed by the controller 30 may be received from another device through a cable or wireless communication and may be stored in a storage device such as a flash memory. The other devices include, for example, a PC and a server connected through a network.

Each step of the post-replacement printing process of the printing apparatus 1 is not limited to the example executed by the controller 30, and a part or the entirety may be executed by another electronic device (for example, ASIC). Each step of the post-replacement printing process may be distributedly executed by a plurality of electronic devices (for example, a plurality of CPUs). Each step of the post-replacement printing process may be reordered, omitted, and added as appropriate. The scope of the present disclosure also includes a mode in which an operating system (OS) and so on running on the printing apparatus 1 executes a part or the entirety of the post-replacement printing process based on a command from the controller 30. For example, the following changes may be made to the post-replacement printing process as appropriate.

The command for performing the correction process may be performed by the user through the operation interface 4, or may be automatically input when it is detected that the exchange of the roll R is completed. The controller 30 may execute the steps S3 to S7 in response to a command for performing the correction process. At least one of first adjustment and second adjustment may be omitted depending on the configuration of the back tension applying device 8. At the time of the first adjustment, the controller 30 may control the first conveyance drive part 9 to drive the first conveyor 7 to convey the print medium in the conveyance direction D until a particular condition is satisfied in a state where conveyance of the print medium by the second conveyor is stopped. At the time of the second adjustment, after the first conveyance, the controller 30 may control the second conveyance drive part 11 to drive the second conveyor 10 to convey the print medium M in the conveyance direction D in a state where conveyance of the print medium M by the first conveyor 7 is stopped.

What is claimed is:

1. A printing apparatus comprising:
a holder configured to hold a long print medium;
a print head configured to print an image on the print medium fed from the holder;
a first conveyor configured to convey the print medium in a conveyance direction from the holder toward the print head and in a return direction opposite to the conveyance direction;
a tensioner configured to apply back tension to the print medium between the holder and the first conveyor;
a first motor configured to drive the first conveyor; and
a controller configured to control the print head and the first motor, the controller being configured to perform a correction process of controlling the first motor to repeat a first conveyance and a second conveyance sequentially a plurality of times, the first conveyance being conveying the print medium in the conveyance direction in a state where the back tension is applied to the print medium by the tensioner, the second conveyance being conveying the print medium in the return direction in a state where the back tension is not applied to the print medium by the tensioner.

2. The printing apparatus according to claim 1, further comprising:
a second conveyor provided downstream of the first conveyor in the return direction, the second conveyor being configured to convey the print medium in the return direction; and
a second motor configured to drive the second conveyor based on control by the controller, wherein the controller is configured to, in the second conveyance, control the first motor and the second motor to drive the first conveyor and the second conveyor to convey the print medium in the return direction and convey the print medium to the holder.

3. The printing apparatus according to claim 2, wherein the holder holds a roll around which the print medium is wound; and
wherein the second conveyor rotates the roll held by the holder to convey the print medium in the return direction such that the print medium is wound around the roll.

4. The printing apparatus according to claim 3, wherein the controller is configured to adjust a rotational speed of the roll rotated by the second conveyor during the second conveyance based on an amount of the print medium wound around the roll.

5. The printing apparatus according to claim 2, wherein the controller is configured to control the first motor and the second motor such that a first length of the print medium between the first conveyor and the second conveyor during the first conveyance is shorter than a second length of the print medium between the first conveyor and the second conveyor during the second conveyance.

6. The printing apparatus according to claim 5, wherein the controller is configured to:
in response to acquiring a command for performing the correction process, perform a first adjustment of controlling the second motor to drive the second conveyor to convey the print medium in the return direction until a first condition is satisfied in a state where conveyance of the print medium by the first conveyor is stopped;
in response to finishing the first adjustment, control the first motor and the second motor to drive the first conveyor and the second conveyor to convey the print medium in the conveyance direction in a state where the back tension of a particular range is applied to the print medium, thereby performing the first conveyance;
after the first conveyance, perform a second adjustment of controlling the first motor to drive the first conveyor to convey the print medium in the return direction until a second condition is satisfied in a state where conveyance of the print medium in the conveyance direction by the second conveyor is stopped;
in response to finishing the second adjustment, control the first motor and the second motor to drive the first conveyor and the second conveyor to convey the print medium in the return direction, thereby performing the second conveyance; and
repeat the first adjustment, the first conveyance, the second adjustment, and the second conveyance sequentially the plurality of times.

7. The printing apparatus according to claim 2, wherein the tensioner is arranged upstream of the first conveyor in the conveyance direction and downstream of the second conveyor in the conveyance direction, the tensioner being configured to contact the print medium and press the print medium in a direction crossing the conveyance direction.

8. The printing apparatus according to claim 7, wherein the tensioner includes:
a support member;
a contact member configured to move relative to the support member and to contact the print medium; and
a spring configured to urge the contact member so as to press the print medium in the direction crossing the conveyance direction.

9. The printing apparatus according to claim 3, wherein the tensioner is configured to apply a particular frictional force to a shaft portion of the roll when the roll rotates in a direction in which the print medium is fed out.

10. The printing apparatus according to claim 2, wherein the first motor and the second motor serve as the tensioner; and
wherein the controller is configured to adjust a conveyance speed of the first conveyor and a conveyance speed of the second conveyor, thereby applying the back tension to the print medium.
